(19) United States
(12) Patent Application Publication
(10) Pub. No.: US 2005/0062899 A1
(43) Pub. Date: Mar. 24, 2005

(54) Display device

(76) Inventors: Norihisa Fukayama, Mobara (JP); Kazuyoshi Tanaka, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/941,895

(22) Filed: Sep. 16, 2004

(30) Foreign Application Priority Data
Sep. 19, 2003 (JP) 2003-327274

(51) Int. Cl. G02F 1/1333

(52) U.S. Cl. 349/58

(57) ABSTRACT

A defective display is obviated by preventing the intrusion of a foreign substance in a gap defined between a constitutional member, such as an upper frame, an intermediate frame, a backlight device or the like, and a display panel and by suppressing the application of a stress to the display panel. A shaped elastic member is interposed between a liquid crystal display panel and a mold of a backlight device. One longitudinal side surface of the shaped elastic member is fixedly mounted on the backlight device and the other longitudinal side surface of the shaped elastic member is non-fixedly mounted on the liquid crystal display panel, such that the other longitudinal side surface is always brought into contact with the liquid crystal display panel to prevent the generation of a gap therebetween.

### BACKGROUND OF THE INVENTION

The present invention relates to a flat panel type display device using a display panel; and, more particularly, the invention relates to a display device which obviates the appearance of a display defect by preventing the intrusion of a foreign substance between an upper frame, an intermediate frame or the like, which constitutes a casing of the display device, and a display panel, and/or by suppressing the application of a stress to the display panel attributed to environmental conditions.

As a display device which is capable of producing a high-definition color display for a notebook type computer or a display monitor, a flat panel type display device has been put into practice or has been studied for future practical use. As such a flat panel type display device, various display devices, including a liquid crystal display device which uses a liquid crystal display panel, an organic electroluminescence display device (an organic EL display device) which uses electroluminescence (particularly, organic electroluminescence) elements, or a field emission type display device which uses field emission elements (EFD) and the like, can be named as examples.

This type of display device is configured such that a display panel constituting an image display screen, a drive circuit printed circuit board and other structural members are integrally incorporated into a casing which is constituted of an upper frame and a lower frame. Alternatively, this type of display device is configured such that a display panel constituting an image display screen, a drive circuit printed circuit board and other structural members are integrally incorporated into a casing which is constituted of an upper frame and a lower frame using a mold (a mold frame, an intermediate frame). A rubber cushion or the like is interposed in a contact portion between the upper frame, the lower frame or the intermediate frame, which constitutes a casing, and a display panel, so as to prevent an external impact from being directly applied to the display panel, or to prevent the generation of surface irregularities attributed to the application of a stress to the display panel based on environmental conditions. Further, the rubber cushion serves to prevent a foreign substance from intruding into a gap between the display panel and the other structural members and from exerting various types of damage to the display device.

For example, in the liquid crystal display device, a backlight which illuminates the liquid crystal display panel is housed in an intermediate frame, the liquid crystal display panel is overlapped on the intermediate frame, and another structural member, such as a printed circuit board, is sandwiched between the upper frame and the lower frame, thus forming an integral body. Polarizers are laminated to the liquid crystal display panel, and a printed circuit board for supplying drive signals is connected to the liquid crystal display panel. These structural members tend to warp due to environmental conditions; and, when the warp is rectified using the upper frame, a stress is applied to the liquid crystal display panel, thus giving rise to a display defect, such as the creation of display irregularities. Accordingly, a rubber cushion is interposed between the upper frame and the liquid crystal display panel, thus forming a clearance therebetween.

Further, in the backlight type liquid crystal display device, an illumination device, which is referred to as “a backlight”, is mounted on a back surface of the liquid crystal display panel. The backlight is roughly classified into two types, that is, a so-called sidelight type backlight and a direct type backlight. In the sidelight type backlight, a linear lamp is mounted on at least one side periphery of a light guide plate formed of a transparent plate. The sidelight type backlight is housed in an intermediate frame, which is referred to as a mold frame, and it is stacked between the intermediate frame and the liquid crystal display panel by way of an optical compensation film. Here, the optical compensation film is constituted of a prism sheet and a diffusion sheet which serve to uniformly and efficiently direct the illumination light from the backlight to the whole lower surface of the liquid crystal display panel.

FIG. 9 is a cross-sectional view of a signal line drive circuit installation side showing the structure of a representative part of a liquid crystal display device having a sidelight type backlight. As seen in the drawing, a backlight BL is mounted on a back surface of the liquid crystal display panel PNL, and these structural members are integrally formed using an upper frame SHD and a lower frame MFL, which constitute a casing. The liquid crystal display panel PNL is configured such that liquid crystal is sandwiched between two glass substrates, and polarizers POL1, POL2 are respectively stacked on a lower surface and an upper surface of the glass substrate. The backlight BL is configured such that a cold cathode fluorescent tube CFL is arranged on a side periphery of a light guide plate GLB in the form of a transparent resin plate, and the cold cathode fluorescent tube CFL is held by a mold MDL together with a lamp house LH and a reflection sheet RF. Here, reference symbol CBL indicates a power supply cable for the cold cathode fluorescent tube CFL.

An optical compensation sheet OPS is mounted on an upper surface of the backlight BL, and the liquid crystal display panel PNL is stacked over the optical compensation sheet OPS. A printed circuit board PCB for supplying drive signals is connected to the liquid crystal display panel PNL. The drive circuit chip is omitted from the drawing. The liquid crystal display panel PNL is mounted on the backlight BL, which is held in the mold MDL, and these structural members are integrally fixed using the upper frame SHD and the lower frame MFL, both of which are made of metal, thus constituting the liquid crystal display device. Here, rubber cushions GC3, GC2, GC1 are interposed between the optical compensation sheet OPS and the mold MDL, between the mold MDL and the liquid crystal display panel PNL, and between the liquid crystal display panel PNL and the upper frame SHD. Here, a conductive rubber is usually used to form the rubber cushion GC1 that is interposed between the liquid crystal display panel PNL and the upper frame SHD. Although the lower frame MFL is formed of a metal plate, and a TCON printed circuit board PS is mounted on a portion thereof, the details thereof are omitted. Further, the whole lower frame MFL may be formed of a resin mold.

As literatures which disclose this type of liquid crystal display device, JP-A-10-039280 (Patent Document 1) is, one example. Patent Document 1 discloses a liquid crystal display panel in which four corners of the liquid crystal display panel are supported using relatively soft members, and center portions of respective sides are supported by rigid members, thus protecting the liquid crystal display panel from rupture attributed to an external force. JP-A-7-281183 (Patent Document 2) discloses a structure in which a liquid crystal display panel is fixed to a casing using rubber cushions.

### SUMMARY OF THE INVENTION

The rubber cushion used in the above-mentioned structure is formed of a solid rubber member having a quadrangular (rectangular or square) cross section; and, hence, although the material per se has elasticity, the rubber cushion does not have an elastic structure which depends on the cross-sectional shape thereof (hereinafter, such an elastic structure will be referred to as a “shaped elastic cushion”).

As seen in FIG. 9, one surface (an upper surface) of the rubber cushion GC1, which is interposed between a glass substrate of the liquid crystal display panel PNL and the upper frame SHD, is fixed to the upper frame SHD side using an adhesive agent or an adhesive tape, while a gap (clearance) C of 0.2 mm to 0.4 mm, for example, is formed between the other surface of the rubber cushion GC1 and the glass substrate of the liquid crystal display panel PNL. As described above, this gap C performs a function of absorbing the warp of the liquid crystal display panel PNL attributed to environmental conditions, thus preventing a stress from being applied to a display region of the liquid crystal display panel PNL.

Further, rubber cushions GC2, GC3 are mounted on the mold frame MDL side using an adhesive agent or an adhesive tape. The rubber cushion GC2, which is interposed between the glass substrate SUB1 of the liquid crystal display panel PNL and the mold MDL, and the rubber cushion GC3, which is interposed between the mold MDL and the optical compensation sheet OPS, do not have the above-mentioned gap (clearance) and are brought into close contact with these structural parts without particularly generating a compression deformation of the rubber cushions GC2, GC3. Accordingly, when the liquid crystal display panel PNL is warped in a direction such that the liquid crystal display panel PNL is brought into contact with the rubber cushion GC1 of the upper frame SHD, there may be a case in which a gap is generated between the rubber cushion GC2 and the liquid crystal display panel PNL. In this case, a foreign substance enter through the gap and intrude onto a light radiation surface of the backlight BL or onto the optical compensation sheet OPS. As a result, dotted black shades will appear in the illumination light, thus causing a defective display. Further, a foreign substance may also intrudethrough a gap between the liquid crystal display panel PNL and the rubber cushion GC1 of the upper frame SHD, and this foreign substance remains in the inside of the casing, thus giving rise to various drawbacks.

Although the drawback attributed to the intrusion of a foreign substance in the liquid crystal display device has been described above, another display device, for example, a display device having no backlight, such as an organic EL display device, a FED display device and the like, also has the following drawback. That is, also with respect to a display panel of the display device having no backlight, periphery of the display panel is covered with a mold, and the display panel and the mold are integrally formed into the display device using an upper mold and a lower mold. Further, by interposing a rubber cushion similar to the rubber cushions shown in FIG. 9 between the mold and the upper frame or the lower frame in a similar manner, an assembling having a given mutual relationship and a sufficient impact resistance are ensured. Further, also with respect to such a display device, it is desirable to prevent the intrusion of a foreign substance between the display panel and the upper frame and to prevent the application of stress to the display panel, which is caused by suppressing the warp at the upper frame, when the display panel is warped. Further, also with respect to the rubber cushion mounted on another portion, it is desirable to prevent the generation of a gap between the members which allow the rubber cushion to be interposed between the members, when these members are deformed.

In view of the above-mentioned circumstances, the display device according to the present invention is characterized in that a shape elastic member (also referred to as a shape elastic cushion) is interposed in a given portion between opposed facing peripheral sides, thus always ensuring adequate sealing between a plurality of plate-like members, including a display panel, which are arranged in a stacked manner, or between frame-like members such as a sheet-like member or an intermediate mold (a mold frame or simply referred to as a mold) or the like, using an elastic function of the shape elastic member, and, at the same time, imparting a sealing function such that, even when the distance between the members is widened due to the generation of a deformation, such as warping of the members, a foreign substance is prevented from intruding into a gap between the members from the position where the shape elastic member is arranged.

The shape elastic member according to the present invention is substantially manufactured by forming an elastic material into a shape which has a restoring force against a bending stress. Here, although it is a principal object of the present invention to prevent the intrusion of a foreign substance into a gap defined between stacked members (including a clearance which is intentionally formed) from outside by interposing the shape elastic member in the gap, it is also another object of the present invention to alleviate the effects of an external impact.

When the display device of the present invention is a liquid crystal display device, it is desirable to always install the shape elastic member used in the display device in the periphery between the liquid crystal display panel and the backlight device. This is because, with respect to the liquid crystal display device, when a foreign substance intrudes between the backlight device and the liquid crystal display panel, the illumination light suffers from irregularities, and these irregularities may impart an adverse influence on the display quality. Here, since the display device of the present invention has the function of preventing the intrusion of a foreign substance, as well as the function of protecting the constitutional members from the effects of external impact, the shape elastic member is provided not only between the liquid crystal display panel and the backlight, but also between other constitutional members in place of the usual rubber cushion. Further, the shape elastic cushion may be interposed between the optical compensation sheet mounted on the backlight device and the liquid crystal display panel.

When the display device of the present invention is a display device which includes organic EL elements or FED elements, by interposing a shape elastic cushion between the display panel on which these elements are formed and another constitutional member, such as an upper frame, a mold frame, a lower frame or the like, it is possible to obviate the display irregularities attributed to warping of the display panel caused by a change of environmental conditions, or it is possible to protect the display device by alleviating an external impact.

According to the present invention, by always ensuring sealing between a plurality of plate-like members, including the display panel, which are arranged in a stacked manner, or between sheet-like members or frame-like members, by using the elastic function of the shape elastic member, even when the members suffer from deformation, such as warping or the like, it is possible to prevent the intrusion of a foreign substance at the position where the shape elastic member is arranged. Further, according to the present invention, due to the interposition of the shape elastic member, the application of a local stress can be obviated, thus also alleviating damage caused by external impact.

The present invention is not limited to the above-mentioned the constitution and constitution of embodiments to be explained later, and various modifications can be made without departing from the technical concept of the present invention.

### BRIEF DESCRIPTION OF THE DRAWINGS

FIG. 1 is an explanatory view of a liquid crystal display device representing an embodiment 1 of the present invention;

FIG. 2A is a perspective view and FIG. 2B is a sectional view of the structure of the shape elastic member in FIG. 1;

FIG. 3A is a sectional view and FIG. 3B is a perspective view of a liquid crystal display device representing an embodiment 2 of the present invention;

FIG. 4A is a sectional view and FIG. 4B is a perspective view of a liquid crystal display device representing an embodiment 3 of the present invention;

FIGS. 5A to 5D are perspective views showing another example of a shape elastic member which can be used in the display device of the present invention;

FIGS. 6A to 6D are diagrams showing examples of a position where a shape elastic member can be installed in the display device of the present invention;

FIG. 7 is a developed perspective view showing an example of the overall constitution of a sidelight type liquid crystal display device to which the present invention is applied;

FIG. 8 is a developed perspective view of a backlight device showing another example of a direct type liquid crystal display device to which the present invention is applied; and

FIG. 9 is a cross-sectional view of an installation side end of signal line drive circuit showing the structure of a representative part of a liquid crystal display device having a sidelight type backlight.

### DETAILED DESCRIPTION OF THE INVENTION

Here, preferred embodiments of the display device of the present invention will be explained in detail in conjunction with the drawings. Here, although the embodiments described hereinafter will be explained by taking a liquid crystal display device as an example, it is needless to say that the present invention is applicable to other types of display device, such as an organic EL display device or a FED.

### EMBODIMENT 1

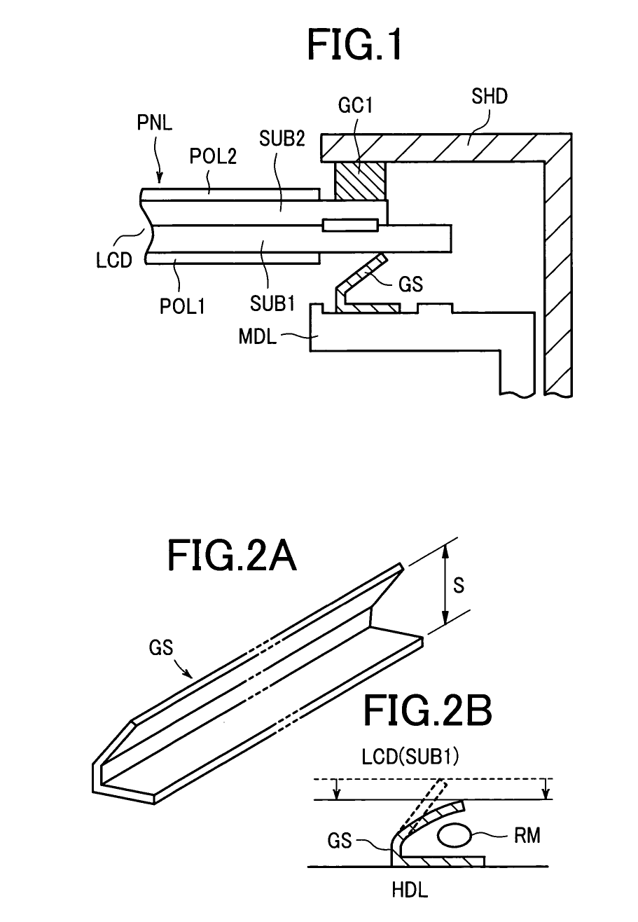

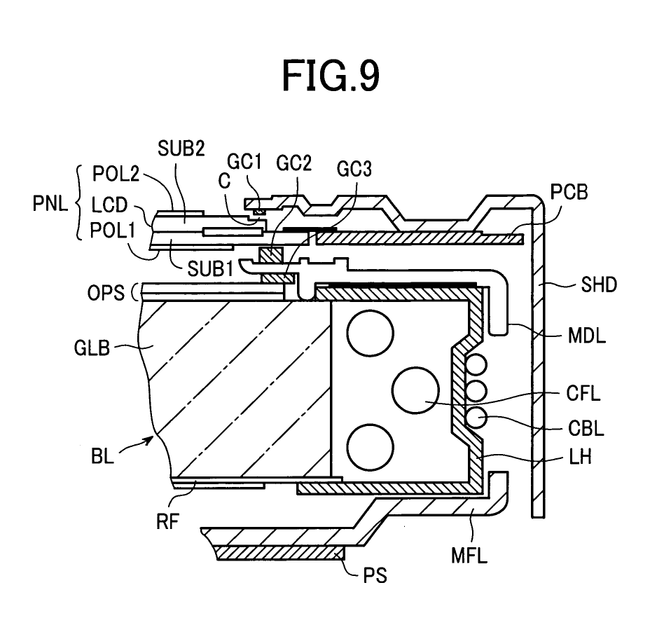

FIG. 1 is a diagram showing an embodiment 1 of the present invention in the form of a cross-sectional view of the structure of a representative part of the basic constitution of the present invention. In FIG. 1, with respect to the backlight device that has already been explained in conjunction with FIG. 9, only the mold MDL is shown, and the light guide plate and the like are omitted from the drawing. Further, the optical compensation sheet mounted on the light guide plate is also omitted from the drawing. A liquid crystal display panel PNL is configured such that a liquid crystal cell LCD is formed by sealing liquid crystal between a pair of glass substrates SUB1, SUB2, and polarizers POL1, POL2 are respectively laminated to a back surface and a front surface of the liquid crystal cell LCD. The liquid crystal display panel PNL is mounted on the backlight device, and a shaped elastic member GS is interposed between the liquid crystal display panel PNL and the mold MDL of the backlight device. Further, an upper frame SHD having a window which exposes a display region of the liquid crystal display panel PNL integrally forms the liquid crystal display device together with a lower frame that is not shown in the drawing (see FIG. 9) in a state such that the upper and lower frames embrace the liquid crystal display panel PNL and the backlight device.

The upper frame SHD is usually provided as a molded member which is formed by blanking a metal sheet using a press, wherein the upper frame SHD faces an end periphery of the liquid crystal display panel PNL in the inside of the window by way of a rubber cushion GC1. Between the upper frame SHD and the liquid crystal display panel PNL, a conductive rubber cushion GC1 similar to the rubber cushion GC1 in FIG. 9 is formed. The liquid crystal display panel PNL is supported on the mold MDL of the backlight device by way of the shaped elastic member GS.

FIGS. 2A and 2B illustrate in more detail the structure and the function of the shaped elastic member shown in FIG. 1. The shape elastic member GS of this embodiment has an approximately L-shaped cross-section, as shown in FIG. 2A, is formed of a material which is substantially the same as the material of a conventional rubber cushion, and is mounted on an upper side (a right side in FIG. 1) at the end of the liquid crystal display panel PNL along the entire length of the upper side. That is, one longitudinal side surface of the shaped elastic member GS is fixedly mounted on the mold MDL of the backlight device using an adhesive agent or an adhesive tape, while the other longitudinal side surface is brought into contact with the liquid crystal display panel PNL (the glass substrate SUB1 of the liquid crystal display panel PNL). In this manner, the other longitudinal side surface is mounted on the glass substrate SUB1 in a non-fixed manner, thus forming a free end.

As shown in FIG. 2B, in the shaped elastic member GS, respective back surfaces of one longitudinal side surface and the other longitudinal side surface (free end side) face each other with a space RM being formed in the direction along one longitudinal side surface and the other longitudinal side surface. When the shaped elastic member GS is fixed to the mold MDL of the backlight device and the liquid crystal display panel PNL is mounted on the shaped elastic member GS, the above-mentioned free end side of the shaped elastic member GS assumes a state in which the free end side approaches the above-mentioned one side surface so as to decrease the size of the space RM, as indicated by the arrow. Further, the shaped elastic member GS generates a resilient force or a biasing force in the direction opposite to the approaching direction due to the elasticity of the free end to expand the space RM, whereby a state in which the shaped elastic member GS is always brought into contact with the liquid crystal display panel PNL is maintained.

It is desirable to manufacture the shaped elastic member GS by extrusion molding of a rubber material from the part of view of productivity. With respect to the mounting portion of the shaped elastic member GS which comes in contact with the liquid crystal display device, the mounting portion is not limited to the whole region of the above-mentioned upper side. For example, the shaped elastic member GS may be formed only on a portion of the upper side and a rubber cushion having a rectangular cross section which has been conventionally used may be mounted on other portions of the upper side. The liquid crystal display panel PNL is connected with the upper frame SHD in a conductive manner using the conductive rubber cushion GC1 at a portion on four sides thereof. In a lateral electric field type (IPS type) liquid crystal display device, when a local stress is applied to the liquid crystal display panel, leaking of light is generated in a black display. Accordingly, by taking into consideration the warping of the liquid crystal display panel PNL, the upper frame SHD or the light guide plate constituting the backlight device, it is necessary to provide a clearance of approximately 0.4 mm to 1.0 mm. Accordingly, the height S of the space RM of the shaped elastic member GS according to this embodiment is set to 0.5mm to 1.5mm in a state in which a load is not applied to the shaped elastic member GS, that is, in a state in which the liquid crystal display panel PNL is not mounted on the shaped elastic member GS. Here, these numeral values merely constitute an example and the above-mentioned clearance should be determined based on the size of the liquid crystal display panel PNL.

According to the constitution of this embodiment, due to the elastic function of the shaped elastic member GS, the free end of the shaped elastic member GS acts to enlarge the space RM so that the shaped elastic member GS maintains a sealed state in which the shaped elastic member GS is always brought into contact with the liquid crystal display panel PNL. Accordingly, even when warping is generated in the laminated member, such as the liquid crystal display panel PNL, there is no possibility that a foreign substance will intrude between the laminated constitutional members in which the shaped elastic member GS is arranged. Here, it is also possible to achieve substantially the same advantageous effects by fixing the shaped elastic member GS to the liquid crystal display panel side by adhesion or the like and by bringing the side which is brought into contact with a mold MDL into a non-fixed state.

### EMBODIMENT 2

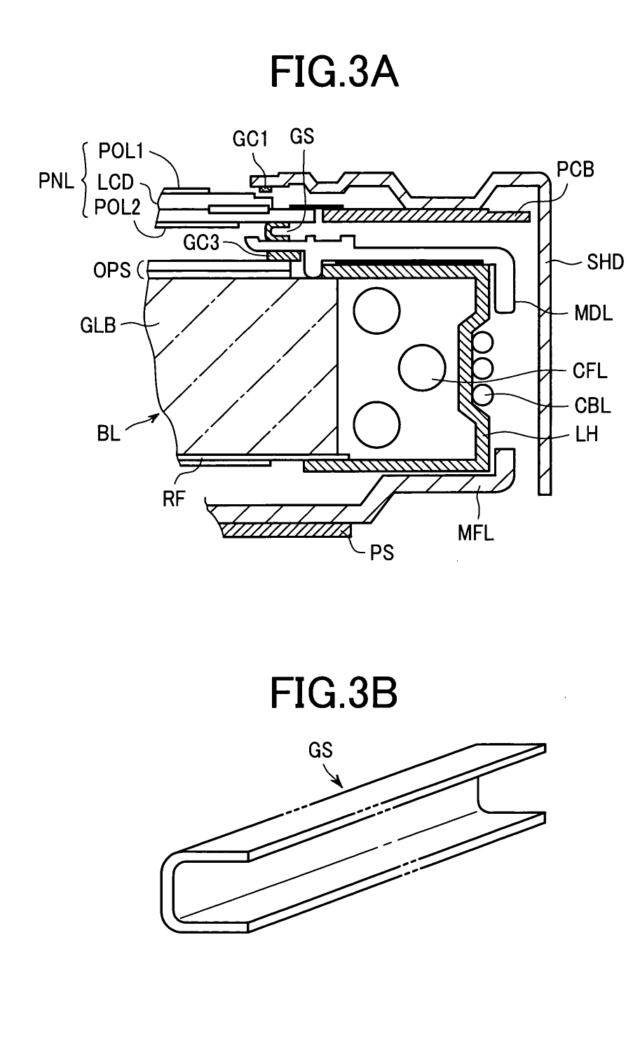

FIG. 3A and FIG. 3B are views of a liquid crystal display device representing an embodiment 2 of the present invention, wherein FIG. 3A is a cross-sectional view of a representative part in the same manner as FIG. 9, and FIG. 3B is a perspective view of the shaped elastic member of this embodiment. The entire constitution of this embodiment is substantially the same as the constitution shown in FIG. 9, except for the shaped elastic member, which is interposed between the liquid crystal display panel PNL and the backlight device. Accordingly, a repeated explanation thereof is omitted unless otherwise necessary.

The embodiment shown in FIG. 3A differs from the embodiment 1 with respect to the point that the shaped elastic member GS, which is interposed between the liquid crystal display panel PNL and the backlight device, has a U-shaped cross section, as shown in FIG. 3B. This shaped elastic member GS, having a U-shaped cross-section, may be manufactured by bending a strip-like rubber member, or it may be manufactured by dividing a tubular body having a rectangular cross section into halves in the longitudinal direction. One longitudinal side surface (lower side surface) of the shaped elastic member GS is fixedly mounted on the mold MDL of the backlight device by an adhesive agent or an adhesive tape, while the other longitudinal side surface (upper side surface) is mounted on the liquid crystal display panel PNL (glass substrate SUB1 of the liquid crystal display panel PNL) in a non-fixed manner, such that the other longitudinal side surface is brought into contact with the glass substrate SUB1, thus forming a free end.

Also, according to the constitution of this embodiment, due to the elastic function of the shaped elastic member GS, the free end of the shaped elastic member GS acts to enlarge the space RM, so that the shaped elastic member GS maintains the state in which the shape elastic member GS is always brought into contact with the liquid crystal display panel PNL. Accordingly, even when warping is generated in the laminated member, such as the liquid crystal display panel PNL, there is no possibility that a foreign substance will intrude between the laminated constitutional members in which the shaped elastic member GS is arranged. Here, it is also possible to achieve substantially the same advantageous effects by fixing the shaped elastic member GS to the liquid crystal display panel side by adhesion or the like and bringing the side which is brought into contact with a mold MDL into a non-fixed state.

### EMBODIMENT 3

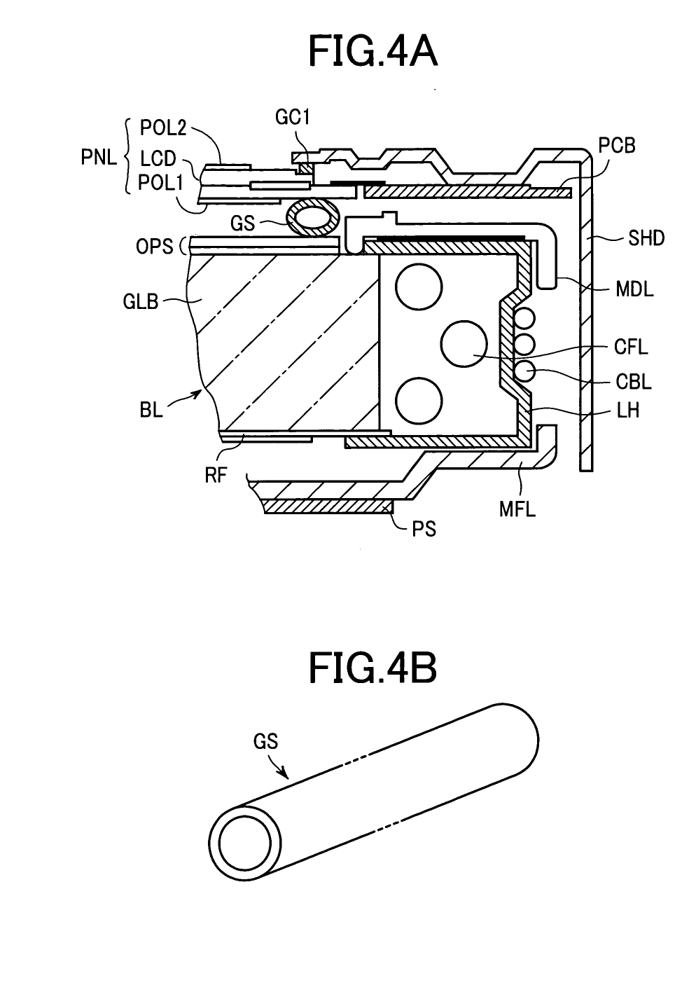

FIG. 4A and FIG. 4B are views of a liquid crystal display device representing an embodiment 3 of the present invention, wherein FIG. 4A is a cross-sectional view of a representative part in the same manner as FIG. 9, and FIG. 4B is a perspective view of the shaped elastic member of this embodiment. The entire constitution of this embodiment is substantially the same as the constitution shown in FIG. 9, except for the shaped elastic member, which is interposed between the liquid crystal display panel PNL and the backlight device. Accordingly, a repeated explanation thereof is omitted unless otherwise necessary.

The shaped elastic member GS of this embodiment has a circular cross section, thus forming a circular tubular body, wherein one longitudinal side surface (lower side surface) of the shaped elastic member GS is fixedly mounted on an optical compensation sheet OPS that is mounted on a backlight device using an adhesive agent or an adhesive tape. On the other hand, the other longitudinal side surface (upper side surface) is brought into contact with and is mounted on the liquid crystal display panel PNL (glass substrate SUB1 of the liquid crystal display panel PNL) in a non-fixed manner, thus forming a free end. By mounting the shaped elastic member GS, which is formed of a tubular body having the circular cross section as shown in FIG. 4B, on the optical compensation sheet OPS and by mounting the liquid crystal display panel PNL on the shaped elastic member GS, the shaped elastic member GS is formed into a body having an elliptical cross section, as shown in FIG. 4A, due to the elasticity of the shaped elastic member GS, thus always sealing the space between them.

Also, according to the constitution of this embodiment, due to the elastic function of the shaped elastic member GS, the free end of the shaped elastic member GS acts to enlarge the space RM so that the shaped elastic member GS maintains a state in which the shaped elastic member GS is always brought into contact with the liquid crystal display panel PNL. Accordingly, even when warping is generated in the laminated member, such as the liquid crystal display panel PNL, there is no possibility that a foreign substance will intrude between the laminated constitutional members in which the shaped elastic member GS is arranged. Here, it is also possible to achieve substantially the same advantageous effects by fixing the shaped elastic member GS to the liquid crystal display panel side by adhesion or the like and by bringing the side which is brought into contact with the optical compensation sheet OPS into a non-fixed state.

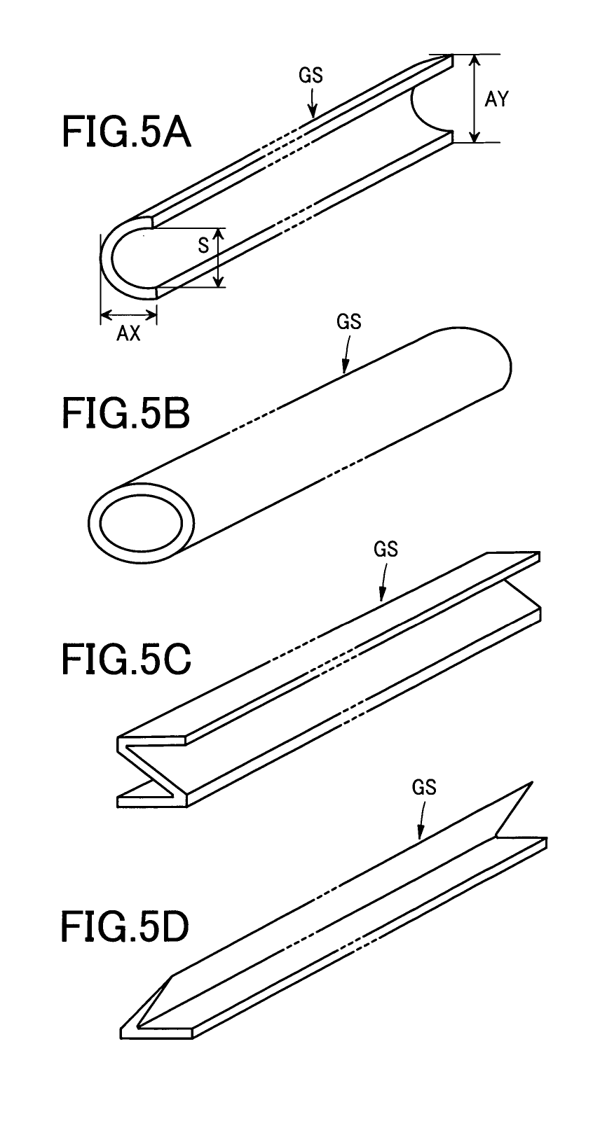

FIG. 5A to FIG. 5D are perspective views showing other examples of a shaped elastic member which can be used in the display device of the present invention. Here, FIG. 5A shows a shaped elastic member having a shape similar to the shape of the shaped elastic member of the embodiment shown in FIG. 3B, and it corresponds to a shape obtained by dividing a tubular body having a circular cross section or a tubular body having an elliptical cross section into halves longitudinally. FIG. 5B shows a shaped elastic member having a shape similar to the shape of the shaped elastic member of the embodiment shown in FIG. 4B, wherein the shaped elastic member is a tubular body having an elliptical cross-sectional shape even before mounting the shape elastic member. The tubular body having an elliptical cross-sectional shape can be handled more easily than a tubular body having a circular cross-sectional shape during the installation operation.

FIG. 5C shows a shaped elastic member having a Z-shape cross section, and FIG. 5D shows a shaped elastic member having an L-shaped cross section. In the shaped elastic member shown in FIG. 5C, one side surface, which constitutes a fixed side surface, and the other side surface, which constitutes a free end, have the same shape, and, hence, either one of these side surfaces can be used as the fixed side. Further, in contrast to the other shaped elastic members, the shaped elastic member shown in FIG. 5C has two of the type of spaces described above. In the shaped elastic member shown in FIG. 5D, the other side surface which constitutes the free end has the thickness thereof gradually narrowed to form a knife edge at a tip end thereof. Due to such a constitution, it is possible to bring the free end into contact with the liquid crystal display panel more reliably.

Here, the structural principle, the manner of operation and advantageous effects of the shaped elastic member will be explained in conjunction with the shaped elastic member shown in FIG. 5A.

It is assumed that the width of the member is AX and the height (sum of the height S of the space RM of the shaped elastic member and the thickness of shape elastic member per se×2) is AY, as seen in FIG. 5A. For example, in the case of a shaped elastic member having a width AX of 2.5 mm and a height AY of 2.2 mm, when a load of 4 gf/cm is applied in the height direction, the height AY is changed to 1.3 mm. Then, when a load of 8 gf/cm is applied in the height direction, the height AY is changed to 0.5 mm. Further, when a load of 10 gf/cm is applied in the height direction, the height AY is changed to 0.4 mm and the height S of the space RM becomes 0 mm. That is, the compression ratio of the height AY becomes 41% when a load of 4 gf/cm is applied, the compression ratio of the height AY becomes 77% when a load of 8 gf/cm is applied, and the compression ratio of the height AY becomes 82% when a load of 10 gf/cm is applied,

When the usual rubber is to be compressed at a compression ratio of approximately 40%, a load of approximately 65 kPa becomes necessary (in case of rubber having a diameter of 50 mm). Compared to this case, the shaped elastic member used in this embodiment can obtain a compression ratio of 40% with a load of approximately 1/40of the load applied to the usual rubber. That is, it is possible to absorb a delicate force applied to the display panel, and, hence, it is possible to prevent the intrusion of a foreign substance.

Here, it is effective to use a member in which the load, which brings the compression ratio of the height to 40%, is set to 4 gf/cm or less. However, it is also possible to obtain the advantageous effect of the present invention even with the use of a member which obtains the compression ratio of 40% with approximately 1/10of the load of the usual rubber, that is, with 16 gf/cm or less.

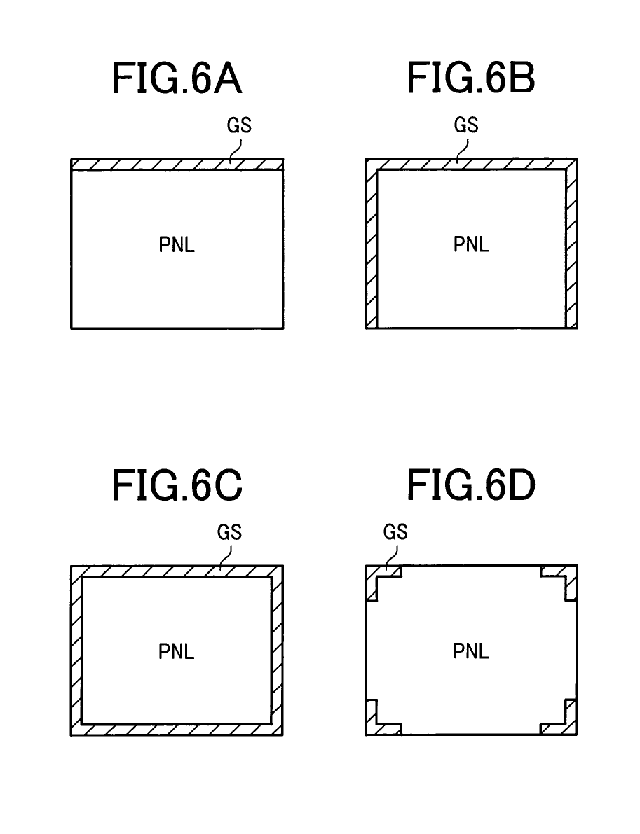

FIG. 6A to FIG. 6D are views of positions where the shaped elastic member in the display device of the present invention is arranged. FIG. 6A shows a case in which the shaped elastic member GS is arranged on the whole region of the upper side of the liquid crystal display panel PNL, FIG. 6B shows a case in which the shaped elastic member GS is arranged on the upper side and both sides of the liquid crystal display panel PNL, and FIG. 6C shows a case in which the shaped elastic member GS is arranged on all sides of the liquid crystal display panel PNL. Further, the shaped elastic members GS may be arranged on four corners of the liquid crystal display panel PNL, as shown in FIG. 6D. The arrangement of the positions of the shaped elastic members may be also determined based on the shape of the sides of the members between which the shaped elastic member is interposed, which are configured to prevent the intrusion of the foreign substance and to have a sufficient impact resistance. Accordingly, there may be a case in which the shaped elastic member is arranged at positions other than the positions shown in FIG. 6A to FIG. 6D. Here, FIG. 6A to FIG. 6D show examples in which the mounting positions of the shaped elastic members are representatively located on the display panel PNL. In the example shown in FIG. 6A, in which the shaped elastic member is installed on the whole region of the upper side of the liquid crystal display panel PNL, the upper sides of the members, which have the shaped elastic member interposed therebetween, are opened, and the upper side is the arrangement position which is at least necessary at the time of transporting the panel in the longitudinal position during the manufacturing step of the display device.

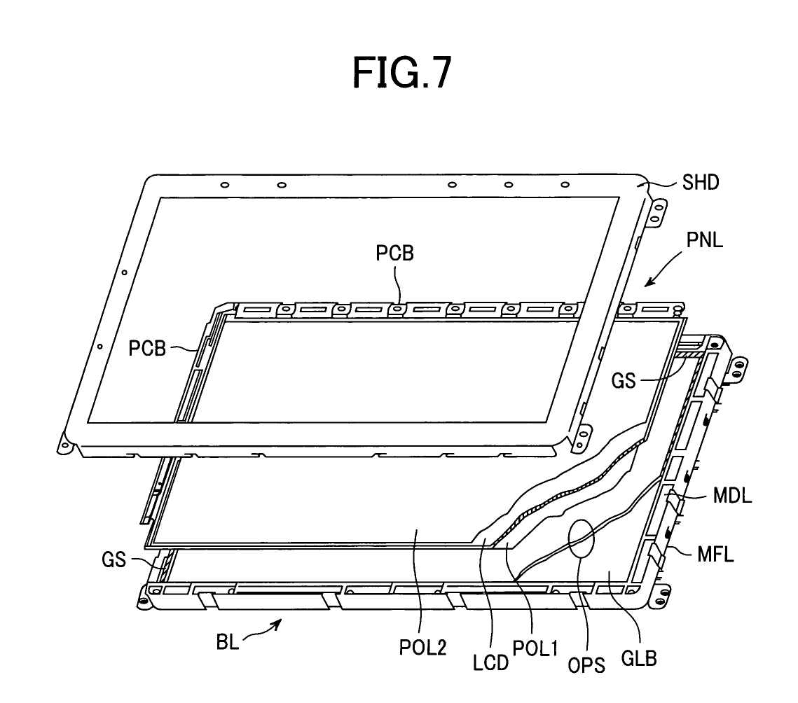

FIG. 7 is a developed perspective view showing one example of the overall constitution of a sidelight type liquid crystal display device to which the present invention is applied. The liquid crystal display panel PNL has drive circuits mounted on a periphery (here, an upper side and a left side) of the liquid crystal display cell and includes a printed circuit board PCB which supplies signals to these drive circuits. Further, the polarizers POL1, POL2 are respectively stacked on front and back surfaces of the liquid crystal display panel PNL. The backlight device BL, which is arranged on the back surface of the liquid crystal display panel PNL, includes the mold MDL which houses the light guide plate GLB therein. The mold MDL is supported on the lower frame MFL. The optical compensation sheet OPS, which is constituted of the prism sheet, and the light diffusion sheet is mounted on the light guide plate GLB.

In this constitutional example, as in the case of the embodiments explained in conjunction with FIG. 1 or FIG. 3A, the shaped elastic cushion GS is mounted on the inner periphery of the mold MDL of the backlight device BL. The liquid crystal display panel PNL is mounted on the mold MDL such that the shaped elastic member GS is interposed therebetween. Further, the liquid crystal display panel PNL is covered with the upper frame SHD from above and the upper frame SHD is connected with the lower frame MFL to integrally form the liquid crystal display device.

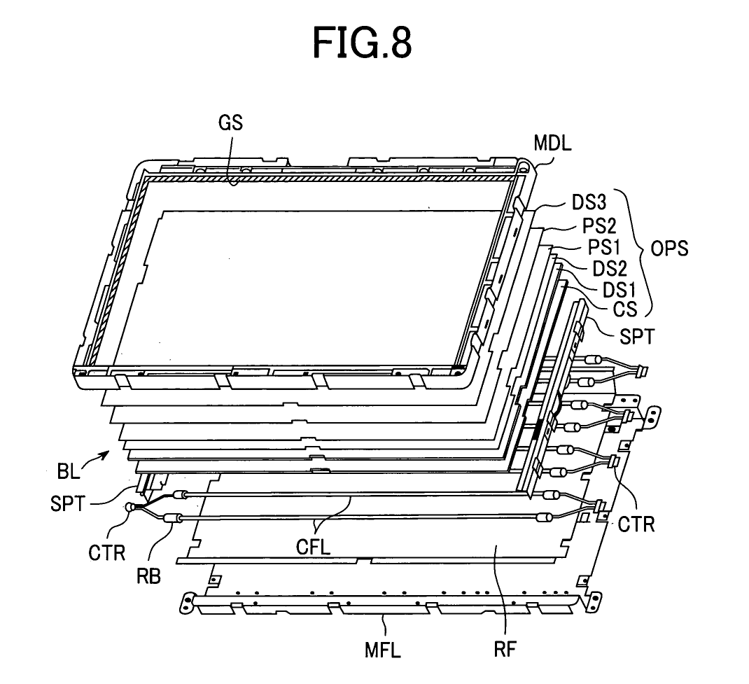

FIG. 8 is a developed perspective view of the backlight device showing another example of a direct type liquid crystal display device to which the present invention is applied. The liquid crystal display panel PNL is omitted from the drawing. The backlight device BL is a so-called direct type in which the optical compensation sheet OP and a plurality of cold cathode fluorescent tubes CFL are held by the mold MDL and the lower frame MFL. In this example, the optical compensation sheet OPS is constituted of a transparent sheet CS, optical diffusion sheets DS1 to DS3 and the prism sheets PS1, PS2. On the back surface of the optical compensation sheet OPS, a plurality of cold cathode fluorescent tubes CFL are arranged in parallel. The cold cathode fluorescent tubes CFL are held on the lower frame MFL by a rubber bushing RB and a support SPT, and electricity is supplied to the cold cathode fluorescent tubes CFL from connectors CTR. Here, a reflection sheet RF is arranged below the cold cathode fluorescent tubes CFL.

The shaped elastic member GS is arranged on the whole inner periphery (four sides) of the mold MDL. The liquid crystal display panel (not shown in the drawing) is mounted on the mold MDL with the shaped elastic member GS interposed therebetween. Further, the liquid crystal display panel is covered with the upper frame (not shown in the drawing) from above, and the upper frame SHD is connected with the lower frame MFL, thus integrally forming the liquid crystal display device.

The display device of the present invention is not limited to a liquid crystal display device, and it is also applicable to an organic EL display device or a FED display device having a foreign substance intrusion prevention structure or an impact resistance structure. Further, the display device is applicable not only to a miniaturized display device of a personal digital assistant or a mobile phone, but also to an intermediate-sized display device, such as that used in a desktop type personal computer and a notebook type personal computer, as well as to a large-sized display device, such as a television receiver set or monitor equipment for other types of digital assistant.

1. A display device comprising:
a display panel;
a mold which holds the display panel;
a frame which covers the display panel and is fixed to the mold; and
a cushion which is arranged between the display panel and the mold, wherein
the cushion is arranged between at least one side of the display panel and the mold,
the cushion includes a first portion which is brought into contact with the display panel and a second portion which is brought into contact with the mold, and
a space is formed between the first portion and the second portion.

2. A display device having a plurality of members, including a display panel, an intermediate mold which exposes a display region of the display panel and holds a periphery of the display panel, an upper frame which has a window to expose the display region and covers the display panel from the display region side, and a lower frame which is positioned below the display panel and houses the display panel in a stacked manner, the display device being integrally formed by interposing a rubber cushion between at least one side of opposing peripheries of the plurality of members, wherein
the rubber cushion is a shaped elastic member which is shaped such that a back surface of one longitudinal side surface thereof which is brought into contact with one member which allows the interposition of the rubber cushion faces a back surface of another longitudinal side surface thereof which is brought into contact with another member with a space defined therebetween, and when the space is interposed between one member and another member by making one member and another member approach each other thus making the space have a narrowed shape, the rubber cushion is elastically biased in the direction opposite to the approaching direction to generate an elasticity so as to enlarge the space, and
both of said one longitudinal side surface which is brought into contact with one member and said other longitudinal side surface which is brought into contact with another member are always held in a contact state with said one member and said other member.

3. A display device which includes a liquid crystal display panel, a backlight device which is mounted on a back surface of the liquid crystal display panel, an upper frame which has a window to expose the display region of the display panel and covers the display panel from the display region side, and a lower frame which is positioned below the backlight device and houses the display panel, the display device being integrally formed by interposing a rubber cushion between the liquid crystal display panel and the upper frame and a rubber cushion between the liquid crystal display panel and the backlight device, wherein
the rubber cushion which is interposed between the liquid crystal display panel and the backlight device is a shaped elastic member which is shaped such that one longitudinal side surface is fixedly mounted on either one of said liquid crystal display panel and said backlight device and another longitudinal side surface is brought into contact with and is non-fixedly mounted on either one of said liquid crystal display panel and said backlight device and,
the shaped elastic member has a back surface of one longitudinal side surface and a back surface of another longitudinal side surface to face each other with a space therebetween in the direction of said one longitudinal side surface and said other longitudinal side surface, and
when the space is narrowed by bringing said one longitudinal side surface and said other longitudinal side surface to approach each other, the shaped elastic member is shaped to have elasticity to resiliently bias in a direction opposite to the approaching direction to enlarge the space, and
said other longitudinal side surface is always held in the contact state with either one of the liquid crystal display panel and the backlight device in a non-fixed manner.

4. A display device according to claim 3, wherein the backlight device is constituted such that a light guide plate and a linear lamp, which is arranged at least along one side periphery of the light guide plate, are supported on an intermediate mold,
an optical compensation sheet is mounted on the liquid crystal display panel side of the light guide plate, and
one longitudinal side surface of the shaped elastic member is fixed to the intermediate mold.

5. A display device according to claim 3, wherein the backlight device is constituted such that a light guide plate and a linear lamp, which is arranged along one side periphery of the light guide plate, are supported on an intermediate mold,
an optical compensation sheet is mounted on the liquid crystal display panel side of the light guide plate, and
one longitudinal side surface of the shaped elastic member is fixed to the optical compensation sheet.

6. A display device according to claim 3, wherein the backlight device is constituted such that a plurality of linear lamps, which are arranged in parallel to the back surface of the liquid crystal display panel, and an optical compensation sheet, including a light diffusion plate which is interposed between the linear lamps and the liquid crystal display panel, are supported on an intermediate mold, and
one longitudinal side surface of the shaped elastic member is fixed to the intermediate mold.

7. A display device according to claim 3, wherein the backlight device is constituted such that a plurality of linear lamps, which are arranged in parallel to the back surface of the liquid crystal display panel, and an optical compensation sheet, including a light diffusion plate which is interposed between the linear lamps and the liquid crystal display panel, are supported on an intermediate mold, and
one longitudinal side surface of the shaped elastic member is fixed to the optical compensation sheet.

8. A display device according to any one of claims 1 to 7, wherein a cross section of the shaped elastic member is either one of, or a modification or a combination of a triangular tubular body with one side cut away, a rectangular tubular body with one side cut away, a circular tubular body or an elliptical tubular body having one side thereof in the longitudinal direction opened, a circular tubular body, an elliptical circular tubular body and a Z-shaped body.
